(19) United States
(12) Patent Application Publication
(10) Pub. No.: US 2022/0297933 A1
(43) Pub. Date: Sep. 22, 2022

(54) TRASH CAN WITH RODENT GUARD AND LATCHING LID

(71) Applicant: SHEILA ELAYWAN, ALLSTON, MA (US)

(72) Inventor: SHEILA ELAYWAN, ALLSTON, MA (US)

(21) Appl. No.: 17/202,792

(22) Filed: Mar. 16, 2021

(51) Int. Cl. B65F 1/16; B65F 1/14

(52) U.S. Cl. CPC B65F 1/1615; B65F 1/1473; B65F 1/1646; B65F 2001/1669

(57) ABSTRACT

The trash can with rodent guard and latching lid is a container. The trash can with rodent guard and latching lid is configured for use in storing refuse. The trash can with rodent guard and latching lid forms a protected space used to contain the refuse. The protected space inhibits the ability of animals to gain access to the refuse contained in the protected space. The trash can with rodent guard and latching lid comprises a trash bin and a sheath structure. The sheath structure forms a sleeve that encloses a portion of the trash bin.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of packing and the handling of materials, more specifically, a refuse receptacle. (B65F1/00)

### SUMMARY OF INVENTION

The trash can with rodent guard and latching lid is a container. The trash can with rodent guard and latching lid is configured for use in storing refuse. The trash can with rodent guard and latching lid forms a protected space used to contain the refuse. The protected space inhibits the ability of animals to gain access to the refuse contained in the protected space. The trash can with rodent guard and latching lid comprises a trash bin and a sheath structure. The sheath structure forms a sleeve that encloses a portion of the trash bin.

These together with additional objects, features and advantages of the trash can with rodent guard and latching lid will be readily apparent to those of ordinary skill in the art upon reading the following detailed description of the presently preferred, but nonetheless illustrative, embodiments when taken in conjunction with the accompanying drawings.

In this respect, before explaining the current embodiments of the trash can with rodent guard and latching lid in detail, it is to be understood that the trash can with rodent guard and latching lid is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the trash can with rodent guard and latching lid.

It is therefore important that the claims be regarded as including such equivalent construction insofar as they do not depart from the spirit and scope of the trash can with rodent guard and latching lid. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a side view of an embodiment of the disclosure.

FIG. 3 is a front view of an embodiment of the disclosure.

FIG. 4 is a rear view of an embodiment of the disclosure.

FIG. 5 is a perspective view of an alternate embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

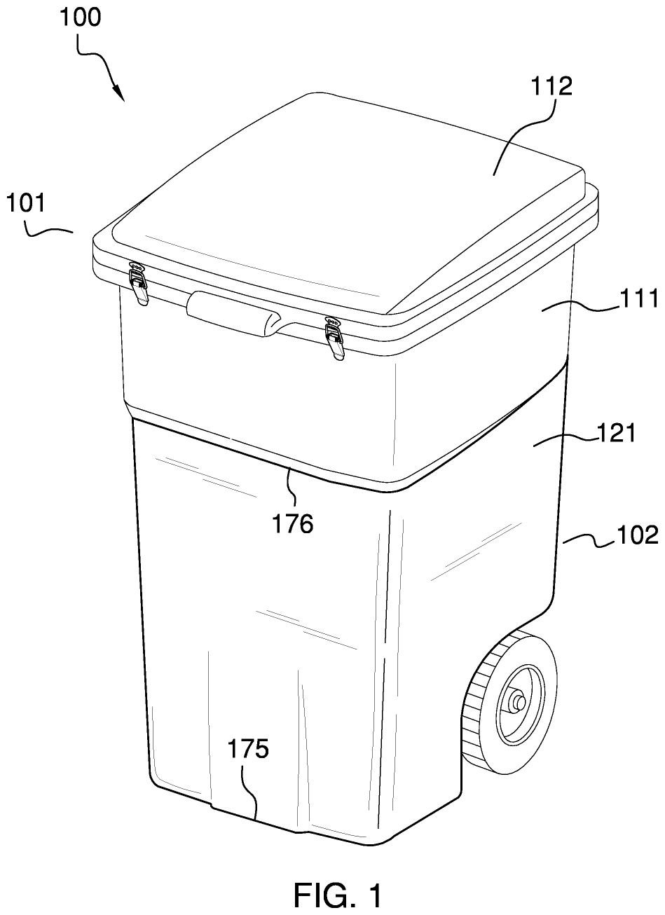

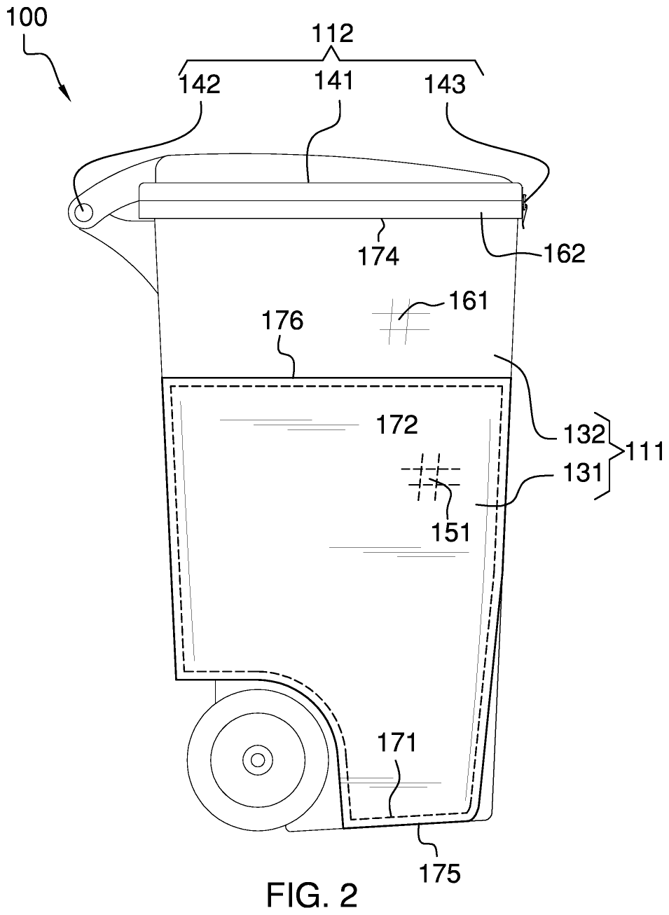

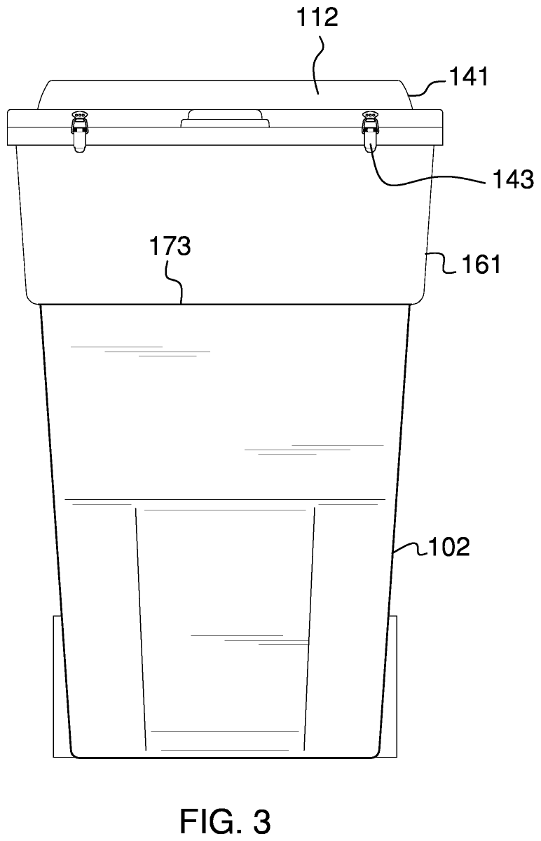

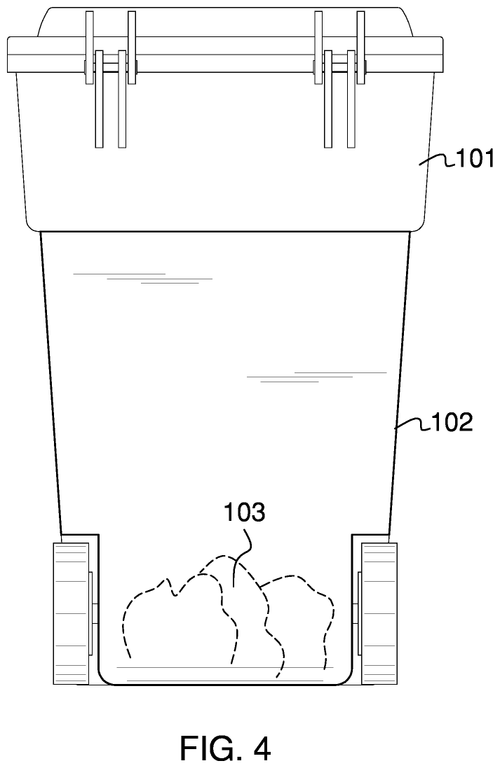

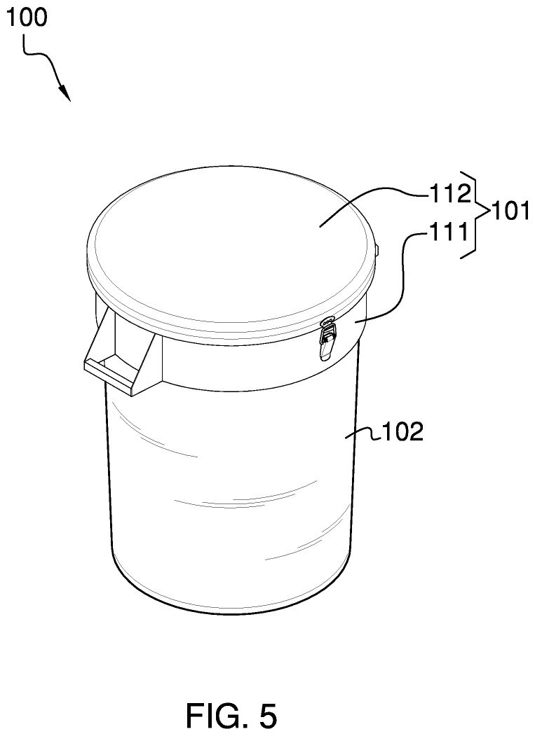

Detailed reference will now be made to one or more potential embodiments of the disclosure, which are illustrated in FIGS. 1 through 5.

The trash can with rodent guard and latching lid 100 (hereinafter invention) is a container. The invention 100 is configured for use in storing refuse 103. The invention 100 forms a protected space used to contain the refuse 103. The protected space inhibits the ability of animals to gain access to the refuse 103 contained in the protected space. The invention 100 comprises a trash bin 101 and a sheath structure 102. The sheath structure 102 forms a sleeve that encloses a portion of the trash bin 101. The refuse 103 is defined elsewhere in this disclosure.

The trash bin 101 is a container. The trash bin 101 is an enclosable structure. The trash bin 101 forms the protected space that encloses the refuse 103. The trash bin 101 is a prism-shaped structure. The trash bin 101 has a composite prism structure. The trash bin 101 comprises a storage pan structure 111 and a lid structure 112.

The storage pan structure 111 is a prism-shaped structure. The storage pan structure 111 is formed as a pan. The storage pan structure 111 is formed with a composite prism shape. The storage pan structure 111 forms the bulk of the protected space created by the trash bin 101. The storage pan structure 111 comprises an inferior pan 131 and a superior extension 132.

The inferior pan 131 is a prism-shaped structure. The inferior pan 131 is a hollow structure. The inferior pan 131 has a pan structure. The inferior pan 131 forms the inferior structure of the trash bin 101. The inferior pan 131 forms the inferior portion of the protected space formed by the trash bin 101. The inferior pan 131 comprises an inferior lateral face 151, a first congruent end 171, and a second congruent end 172.

The inferior lateral face 151 forms the lateral face of the prism structure of the inferior pan 131. The inferior lateral face 151 forms a portion of the vertically oriented containment boundaries of the protected space formed by the trash bin 101. The first congruent end 171 forms the closed face of the pan structure of the inferior pan 131. The first congruent end 171 forms the inferior surface of the inferior pan 131. The first congruent end 171 is the surface of the inferior pan 131 that inserts into the open face of the pan structure of the sheath structure 102. The second congruent end 172 forms the open face of the pan structure of the inferior pan 131. The second congruent end 172 forms the superior face of the inferior pan 131. The second congruent end 172 is the face of the inferior pan 131 that is distal from the first congruent end 171.

The superior extension 132 is a prism-shaped structure. The superior extension 132 is a hollow structure. The superior extension 132 has a tubular structure. The superior extension 132 attaches to the inferior pan 131 to form a composite prism structure. The superior extension 132 forms the superior structure of the trash bin 101. The lateral face of the prism structure of the superior extension 132 forms the vertical containment surfaces of the protected space formed by the trash bin 101. The superior extension 132 extends the elevation of the protected space formed by the trash bin 101 above the open face of the pan structure of the inferior pan 131. The superior extension 132 comprises a superior lateral face 161, a rim 162, a third congruent end 173, and a fourth congruent end 174.

The superior lateral face 161 forms the lateral face of the prism structure of the superior extension 132. The superior lateral face 161 forms a portion of the vertically oriented containment boundaries of the protected space formed by the trash bin 101. The rim 162 is a rim 162 that is formed around the fourth congruent end 174 of the superior extension 132 of the storage pan structure 111. The plurality of lid latches 143 physically secure the lid pan 141 to the rim 162 of the superior extension 132 of the storage pan structure 111.

The third congruent end 173 is an open congruent end of the tubular structure of the superior extension 132. The third congruent end 173 of the superior extension 132 attaches to the second congruent end 172 of the inferior pan 131. The third congruent end 173 of the superior extension 132 and the second congruent end 172 of the inferior pan 131 are joined to form a fluid impermeable structure. The fourth congruent end 174 is an open congruent end of the tubular structure of the superior extension 132. The fourth congruent end 174 is the face of the prism structure of the superior extension 132 that is distal from the third congruent end 173. The fourth congruent end 174 forms the superior surface of the storage pan structure 111. The fourth congruent end 174 provides access into the protected space formed by the storage pan structure 111.

The lid structure 112 is a prism-shaped structure. The lid structure 112 is formed as a pan. The inner dimension of the lid structure 112 is greater than the outer dimension of the open face of the storage pan structure 111 such that the open face of the storage pan structure 111 inserts into the open face of the pan structure of the lid structure 112. The lid structure 112 comprises a lid pan 141, a lid hinge 142, and a plurality of lid latches 143.

The lid pan 141 is a prism-shaped structure. The lid pan 141 is formed as a pan. The lid pan 141 encloses the open face of the fourth congruent end 174 of the superior extension 132 of the storage pan structure 111. The inner dimension of the lid pan 141 is greater than the outer dimension of the fourth congruent end 174 of the superior extension 132 such that the fourth congruent end 174 of the superior extension 132 inserts into the open face of the pan structure of the lid pan 141.

The lid hinge 142 is a hinge structure. The lid hinge 142 attaches the lid pan 141 to the fourth congruent end 174 of the superior extension 132 of the storage pan structure 111. The lid hinge 142 attaches the lid pan 141 to the superior extension 132 such that the lid pan 141 rotates relative to the fourth congruent end 174. The lid hinge 142 controls access into the protected space formed by the trash bin 101 by controlling access to the fourth congruent end 174 of the superior extension 132.

The plurality of lid latches 143 forms a fastening structure that secures the lid pan 141 to the fourth congruent end 174 of the storage pan structure 111 when the lid pan 141 is in the closed position. The plurality of lid latches 143 inhibits animals from entering the protected space formed by the trash bin 101 through the fourth congruent end 174 of the superior extension 132.

The sheath structure 102 is a mechanical structure. The sheath structure 102 is a prism-shaped structure. The sheath structure 102 has a pan structure. The sheath structure 102 is an armor structure. The sheath structure 102 encloses a portion of the trash bin 101. The sheath structure 102 is formed from metal. The sheath structure 102 forms a portion of the exterior surface of the invention 100. The metal structure of the sheath structure 102 inhibits animals from chewing their way into the protected space formed by the trash bin 101.

The sheath structure 102 is geometrically similar to the inferior pan 131 of the trash bin 101. The inner dimension of the open face of the pan structure of the sheath structure 102 is greater than the outer dimension of the first congruent end 171 of the inferior pan 131 such that the inferior pan 131 inserts into the sixth congruent end 176 of the sheath structure 102. The sheath structure 102 is sized such that the inferior pan 131 inserts into the sheath structure 102 with a tight fit. The sheath structure 102 forms the armor structure around the storage pan structure 111 of the trash bin 101. The sheath structure 102 is formed from a metal sheeting. The metal sheeting structure of the sheath structure 102 inhibits animals from chewing their way into the protected space formed by the trash bin 101.

The sheath structure 102 comprises a sheath lateral face 121, a fifth congruent end 175, and a sixth congruent end 176. The sheath lateral face 121 forms the lateral face of the prism structure of the sheath structure 102. The fifth congruent end 175 is the closed congruent end of the pan structure of the sheath structure 102. The fifth congruent end 175 forms the inferior surface of the invention 100. The sixth congruent end 176 is the open congruent end of the pan structure of the sheath structure 102. The first congruent end 171 of the storage pan structure 111 inserts into the sixth congruent end 176 of the sheath structure 102.

The following definitions were used in this disclosure:

Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.

Anterior: As used in this disclosure, anterior is a term that is used to refer to the front side or direction of a structure. When comparing two objects, the anterior object is the object that is closer to the front of the structure.

Armor: As used in this disclosure, armor refers to a rigid structure used to form a guard that creates a protected space.

Barrier: As used in this disclosure, a barrier is a physical obstacle that forms a boundary between a first space and a second space. The barrier prevents the passage of an object between the first space and the second space.

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Composite Prism: As used in this disclosure, a composite prism refers to a structure that is formed from a plurality of structures selected from the group consisting of a prism structure and a pyramid structure. The plurality of selected structures may or may not be truncated. The plurality of prism structures are joined together such that the center axes of each of the plurality of structures are aligned. The congruent ends of any two structures selected from the group consisting of a prism structure and a pyramid structure need not be geometrically similar.

Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.

Copolymer: As used in this disclosure, a copolymer is a polymer formed from two or more repeating molecules (also referred to as monomers).

Correspond: As used in this disclosure, the term correspond is used as a comparison between two or more objects wherein one or more properties shared by the two or more objects match, agree, or align within acceptable manufacturing tolerances.

Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.

Distal: As used in this disclosure, distal refers to a directional sense or location of an object. Specifically, distal refers to a first object, or a side of a first object, that is distal from the medial axis, or more proximal to the side of the object, relative to a second object, or side of a second object.

Elevation: As used in this disclosure, elevation refers to the span of the distance in the superior direction between a specified horizontal surface and a reference horizontal surface. Unless the context of the disclosure suggest otherwise, the specified horizontal surface is the supporting surface the potential embodiment of the disclosure rests on. The infinitive form of elevation is to elevate.

Exterior: As used in this disclosure, the exterior is used as a relational term that implies that an object is not contained within the boundary of a structure or a space.

Fitted: As used in this disclosure, the term fitted refers to two geometrically similar structures wherein the smaller geometrically similar structure inserts into the second geometrically similar structure with a tight fit.

Force of Gravity: As used in this disclosure, the force of gravity refers to a vector that indicates the direction of the pull of gravity on an object at or near the surface of the earth.

Form Factor: As used in this disclosure, the term form factor refers to the size and shape of an object.

Flush: As used in this disclosure, the term flush is used to describe the alignment of a first surface and a second surface to form a single structure selected from the group consisting of a Euclidean plane and a non-Euclidean plane.

Friction: As used in this disclosure, friction refers to a force that occurs between two objects that are in relative motion while in contact with each other. The force resists the relative motion of the two objects. More technically, friction refers to an exchange of energy between two objects that are in contact with each other that converts the energy of a directed relative motion between the two objects into randomly directed motions of the molecules that form both objects.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1.

Hinge: As used in this disclosure, a hinge is a device that permits the turning, rotating, or pivoting of a first object relative to a second object. A hinge designed to be fixed into a set position after rotation is called a locking hinge. A spring loaded hinge is a hinge formed as an elastic structure. The elastic structure of the spring loaded hinge is deformed under a rotating force such that the elastic structure returns the spring loaded hinge back to its relaxed shape after the rotating force is removed from the spring loaded hinge.

Horizontal: As used in this disclosure, horizontal is a directional term that refers to a direction that is either: 1) parallel to the horizon; 2) perpendicular to the local force of gravity, or, 3) parallel to a supporting surface. In cases where the appropriate definition or definitions are not obvious, the second option should be used in interpreting the specification. Unless specifically noted in this disclosure, the horizontal direction is always perpendicular to the vertical direction.

Inferior: As used in this disclosure, the term inferior refers to a directional reference that is parallel to and in the same direction as the force of gravity when an object is positioned or used normally.

Inner Dimension: As used in this disclosure, the term inner dimension describes the span from a first inside or interior surface of a container to a second inside or interior surface of a container. The term is used in much the same way that a plumber would refer to the inner diameter of a pipe.

Interior: As used in this disclosure, the interior is used as a relational term that implies that an object is contained within the boundary of a structure or a space.

Latch: As used in this disclosure, a latch is a fastening or locking mechanism commonly used to secure a lid, a door, or, a gate.

Lateral: As used in this disclosure, the term lateral refers to an axis of an object that is perpendicular in the transverse (posterior to anterior) direction and the sagittal (superior to inferior) direction. The distal surfaces of an object that intersect the lateral axis are often informally referred to as the “sides” of the object. The lateral axis is usually perpendicular to the primary sense of direction of the object. A lateral face refers to the surfaces of a prism structure that run between the congruent ends of the prism. Movement in a lateral direction is often called “sideways” movement.

Left and Right: As used in this disclosure, the terms left and right are directional references associated with an object. The object is further defined with an anterior surface and a posterior surface. The terms left and right are standardized naming conventions for the lateral directions of the object. The terms left and right use the human body for the initial definition of the orientation. Specifically, when a human body is viewed from posterior side towards the anterior side, the left side of the human body is the lateral side of the human body that contains the heart. The right side of the human body is the lateral side of the body that contains the bulk of the liver. The left and right sides of the human body remain unchanged by changes to the direction from which the human body is viewed. The left side of any object is the same side as the left side of the human body when the object is viewed is viewed from posterior side towards the anterior side. The right side of any object is the same side as the right side of the human body when the object is viewed is viewed from posterior side towards the anterior side. The left and right sides of the object remain unchanged by changes to the direction from which the object is viewed.

Lid: As used in this disclosure, a lid is a removable cover that is placed over an opening of a hollow structure to enclose the hollow structure.

Metal: As used in this disclosure, a metal is an element that readily loses electrons or an alloy formed from a plurality of such elements. General properties of metals include, but are not limited to, the ability to conduct heat, conduct electricity, malleability, and the ability to be drawn into a wire. For the purposes of this disclosure, the term metal is assumed to include the transition metals (columns 3-12 of the periodic table) and aluminum, tin, and lead. The alkali metals (columns 1 of the periodic table) and the alkali earth metals (column 2 of the periodic table) are assumed to be excluded from this definition.

Monomer: As used in this disclosure, a monomer refers to a molecular structure that bonds to itself in a repeating manner to form a polymer.

Negative Space: As used in this disclosure, negative space is a method of defining an object through the use of open or empty space as the definition of the object itself, or, through the use of open or empty space to describe the boundaries of an object.

One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction.

Organic: As used in this disclosure, organic refers to a carbon-based chemical structure. A limited number of carbon-based salts are traditionally considered inorganic chemical structures and are excluded from the study of organic chemistry.

Outer Dimension: As used in this disclosure, the term outer dimension describes the span from a first exterior or outer surface of a tube or container to a second exterior or outer surface of a tube or container. The term is used in much the same way that a plumber would refer to the outer diameter of a pipe.

Pan: As used in this disclosure, a pan is a hollow and prism-shaped containment structure. The pan has a single open face. The open face of the pan is often, but not always, the superior face of the pan. The open face is a surface selected from the group consisting of: a) a congruent end of the prism structure that forms the pan; and, b) a lateral face of the prism structure that forms the pan. A semi-enclosed pan refers to a pan wherein the closed end of prism structure of the pan and/or a portion of the closed lateral faces of the pan is are open.

Perimeter: As used in this disclosure, a perimeter is one or more curved or straight lines that bounds an enclosed area on a plane or surface. The perimeter of a circle is commonly referred to as a circumference.

Plastic: As used in this disclosure, plastic refers to a manufactured material that is formed from a structure selected from the group consisting of a polymer or a copolymer. Unless stated otherwise, this disclosure assumes that the plastic is formed from organic monomers.

Polymer: As used in this disclosure, a polymer refers to a molecular chain that comprises multiple repeating units known as monomers. The repeating unit may be an atom or a molecular structure.

Posterior: As used in this disclosure, posterior is a term that is used to refer to the side of an object that is distal or in the opposite direction of the anterior side. When comparing two items, the posterior item is the item that is distal from the anterior of the object.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Protected Space: As used in this disclosure, a protected space is a negative space within which an object is stored. The protected space is enclosed by a barrier structure that: a) prevents damage to the object contained within the protected space; b) maintains an environment suitable within the protected space that is appropriate for the object; or, c) protects the object within the protected space from potential dangers that are outside of the protected space.

Refuse: As used in this disclosure, refuse refers to one or more items of low value that are removed from a place for subsequent disposal. Trash is a synonym for refuse.

Rim: As used in this disclosure, a rim is an outer edge or border that follows along the perimeter of an object.

Tight Fit: As used in this disclosure, a tight fit refers to the insertion of a first object into a second object such that there is not a lot of space between the first object and the second object. By not a lot of space is meant that friction occurs when the first object moves within the second object. See fitted.

Superior: As used in this disclosure, the term superior refers to a directional reference that is parallel to and in the opposite direction of the force of gravity when an object is positioned or used normally.

Vertical: As used in this disclosure, vertical refers to a direction that is either: 1) perpendicular to the horizontal direction; 2) parallel to the local force of gravity; or, 3) when referring to an individual object the direction from the designated top of the individual object to the designated bottom of the individual object. In cases where the appropriate definition or definitions are not obvious, the second option should be used in interpreting the specification. Unless specifically noted in this disclosure, the vertical direction is always perpendicular to the horizontal direction.

Wheel: As used in this disclosure, a wheel is a circular object that revolves around an axle or an axis and is fixed below an object to enable it to move easily over the ground. For the purpose of this disclosure, it is assumed that a wheel can only revolve in a forward and a backward direction. Wheels are often further defined with a rim and spokes. Spokes are also commonly referred to as a wheel disk.

With respect to the above description, it is to be realized that the optimum dimensional relationship for the various components of the invention described above and in FIGS. 1 through 5 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A trash can with rodent guard and latching lid comprising
a trash bin and a sheath structure;
wherein the sheath structure forms a sleeve that encloses a portion of the trash bin.

2. The trash can with rodent guard and latching lid according to claim 1
wherein the trash can with rodent guard and latching lid is a container;
wherein the trash can with rodent guard and latching lid is configured for use in storing refuse;
wherein the trash can with rodent guard and latching lid forms a protected space used to contain the refuse.

3. The trash can with rodent guard and latching lid according to claim 2
wherein the trash bin is a container;
wherein the trash bin is an enclosable structure;
wherein the trash bin forms the protected space that encloses the refuse;
wherein the trash bin has a composite structure.

4. The trash can with rodent guard and latching lid according to claim 3
wherein the trash bin comprises a storage pan structure and a lid structure;
wherein the lid structure attaches to the storage pan structure.

5. The trash can with rodent guard and latching lid according to claim 4
wherein the storage pan structure is formed as a pan;
wherein the storage pan structure is formed with a composite shape;
wherein the storage pan structure forms the bulk of the protected space created by the trash bin.

6. The trash can with rodent guard and latching lid according to claim 5
wherein the lid structure is formed as a pan;
wherein the inner dimension of the lid structure is greater than the outer dimension of the open face of the storage pan structure such that the open face of the storage pan structure inserts into the open face of the pan structure of the lid structure.

7. The trash can with rodent guard and latching lid according to claim 6
wherein the sheath structure is a mechanical structure;
wherein the sheath structure has a pan structure;
wherein the sheath structure is an armor structure;
wherein the sheath structure encloses a portion of the trash bin;
wherein the sheath structure is formed from metal;
wherein the sheath structure forms a portion of the exterior surface of the trash can with rodent guard and latching lid.

8. The trash can with rodent guard and latching lid according to claim 7
wherein the storage pan structure comprises an inferior pan and a superior extension;
wherein the inferior pan is a hollow structure;
wherein the inferior pan has a pan structure;
wherein the inferior pan forms the inferior structure of the trash bin;
wherein the inferior pan forms the inferior portion of the protected space formed by the trash bin;
wherein the superior extension is a hollow structure;
wherein the superior extension has a tubular structure;
wherein the superior extension attaches to the inferior pan to form a composite structure;
wherein the superior extension forms the superior structure of the trash bin;
wherein the lateral face of the superior extension forms the vertical containment surfaces of the protected space formed by the trash bin;
wherein the superior extension extends the elevation of the protected space formed by the trash bin above the open face of the pan structure of the inferior pan.

9. The trash can with rodent guard and latching lid according to claim 8
wherein the lid structure comprises a lid pan, a lid hinge, and a plurality of lid latches;
wherein the lid hinge attaches the lid pan to storage pan structure;
wherein the plurality of lid latches secures the lid pan to storage pan structure.

10. The trash can with rodent guard and latching lid according to claim 9
wherein the inferior pan comprises an inferior lateral face, a first congruent end, and a second congruent end;
wherein the superior extension comprises a superior lateral face, a rim, a third congruent end, and a fourth congruent end;
wherein the inferior lateral face forms the lateral face of the inferior pan;
wherein the inferior lateral face forms a portion of the vertically oriented containment boundaries of the protected space formed by the trash bin;
wherein the first congruent end forms the closed face of the pan structure of the inferior pan;
wherein the first congruent end forms the inferior surface of the inferior pan;
wherein the first congruent end is the surface of the inferior pan that inserts into the open face of the pan structure of the sheath structure;
wherein the second congruent end forms the open face of the pan structure of the inferior pan;
wherein the second congruent end forms the superior face of the inferior pan;
wherein the second congruent end is the face of the inferior pan that is distal from the first congruent end;
wherein the superior lateral face forms the lateral face of the superior extension;
wherein the superior lateral face forms a portion of the vertically oriented containment boundaries of the protected space formed by the trash bin;
wherein the rim is a rim that is formed around the fourth congruent end of the superior extension of the storage pan structure;
wherein the plurality of lid latches physically secure the lid pan to the rim of the superior extension of the storage pan structure;
wherein the third congruent end is an open congruent end of the tubular structure of the superior extension;
wherein the third congruent end of the superior extension attaches to the second congruent end of the inferior pan;
wherein the third congruent end of the superior extension and the second congruent end of the inferior pan are joined to form a fluid impermeable structure;
wherein the fourth congruent end is an open congruent end of the tubular structure of the superior extension;
wherein the fourth congruent end is the face of the superior extension that is distal from the third congruent end;
wherein the fourth congruent end forms the superior surface of the storage pan structure;
wherein the fourth congruent end provides access into the protected space formed by the storage pan structure.

11. The trash can with rodent guard and latching lid according to claim 10
wherein the lid pan is formed as a pan;
wherein the lid pan encloses the open face of the fourth congruent end of the superior extension of the storage pan structure;
wherein the inner dimension of the lid pan is greater than the outer dimension of the fourth congruent end of the superior extension such that the fourth congruent end of the superior extension inserts into the open face of the pan structure of the lid pan.

12. The trash can with rodent guard and latching lid according to claim 11
wherein the lid hinge is a hinge structure;
wherein the lid hinge attaches the lid pan to the fourth congruent end of the superior extension of the storage pan structure;
wherein the lid hinge attaches the lid pan to the superior extension such that the lid pan rotates relative to the fourth congruent end;
wherein the lid hinge controls access into the protected space formed by the trash bin by controlling access to the fourth congruent end of the superior extension.

13. The trash can with rodent guard and latching lid according to claim 12
wherein the plurality of lid latches forms a fastening structure that secures the lid pan to the fourth congruent end of the storage pan structure when the lid pan is in the closed position;
wherein the plurality of lid latches inhibits animals from entering the protected space formed by the trash bin through the fourth congruent end of the superior extension.

14. The trash can with rodent guard and latching lid according to claim 13
wherein the sheath structure is geometrically similar to the inferior pan of the trash bin;
wherein the inner dimension of the open face of the pan structure of the sheath structure is greater than the outer dimension of the first congruent end of the inferior pan such that the inferior pan inserts into the sixth congruent end of the sheath structure.

15. The trash can with rodent guard and latching lid according to claim 14
wherein the sheath structure is sized such that the inferior pan inserts into the sheath structure with a tight fit;
wherein the sheath structure forms the armor structure around the storage pan structure of the trash bin;
wherein the sheath structure is formed from a metal sheeting;
wherein the metal sheeting structure of the sheath structure inhibits animals from chewing their way into the protected space formed by the trash bin.

16. The trash can with rodent guard and latching lid according to claim 15
wherein the sheath structure comprises a sheath lateral face, a fifth congruent end, and a sixth congruent end;
wherein the sheath lateral face forms the lateral face of the sheath structure;
wherein the fifth congruent end is the closed congruent end of the pan structure of the sheath structure;
wherein the fifth congruent end forms the inferior surface of the trash can with rodent guard and latching lid;
wherein the sixth congruent end is the open congruent end of the pan structure of the sheath structure;
wherein the first congruent end of the storage pan structure inserts into the sixth congruent end of the sheath structure.
